(19) United States
(12) Patent Application Publication
(10) Pub. No.: US 2014/0278693 A1
(43) Pub. Date: Sep. 18, 2014

(54) System and Method for Cross-Plant Bill of Materials

(71) Applicant: SAP AG, Walldorf (DE)

(72) Inventors: Eryi Zhang, Heidelberg (DE); Philippe Drouin, Sinsheim (DE); Uwe Frankenhauser, Leimen (DE); Andreas Stier, Malsch (DE); Jochen Thierer, Bruchsal (DE)

(73) Assignee: SAP AG, Walldorf (DE)

(21) Appl. No.: 13/830,046

(22) Filed: Mar. 14, 2013

(51) Int. Cl. G06Q 10/06

(52) U.S. Cl. CPC G06Q 10/06313
USPC 705/7.23

(57) ABSTRACT

Systems and methods for generating a cross-plant bill of materials (BOM) for a particular final end product that can be used by a central business system for performing various business analysis and processes quickly and efficiently are disclosed. The cross-plant BOM can include information from multiple bills of materials (BOMs) for multiple component products produced by multiple manufacturing plants. The list of manufacturing plants participating in the production of a particular end product is referred to as a plant group for business entities. The BOMs for the component products produced by various plants within the plant group for a final end product are inserted into or associated with the BOM for the final end product that includes the component products.

### BACKGROUND

The present disclosure relates to cross-plant bills of materials (BOMs) for mixed-source products in distributed manufacturing environments, and in particular, to systems and methods for generating cross-plant BOMs. Cross-plant BOMs can be used for analysis and management of material procurement logistics, manufacturing planning, and sales for compliance with various rules, laws, and regulations.

Unless otherwise indicated herein, the approaches described in this section are not prior art to the claims in this application and are not admitted to be prior art by inclusion in this section.

In distributed manufacturing systems, the component products for a particular end product can be sourced from one or several internal manufacturing plants, or procured externally from external plants. Each of the component products can be received in an assembly plant for the final step of production or assembly of the end product. The description of the component products in the end product, and the sequential relationship among the component products, are typically represented by a BOM for the end product. When the end product is complete and ready for disposition (e.g., sale, shipment, export, or consumption), there are various legal, regulatory, environmental, taxation, and business requirements with which the business practices or processes need to comply. Analysis of the BOM for the end product and the BOMs for the component products included in the BOM of the end product can usually yield the information necessary for compliance with such requirements. For example, information in the BOMs is used for determining eligibility for preferential customs duties based on the location of the plants from which the majority of the component products were received. Additionally, the information in the BOMs can also be used to verify the assignment of applicable regulatory licenses for foreign trade business.

To comply with the applicable requirements, many businesses use various types of specialized central business systems to perform the necessary analysis of the information included in the BOMs associated with the end and component products. To accurately perform the analysis, the central business systems need timely and complete information about the end product and its component products. Much of the necessary information is included in the BOM associated with the end product. For example, FIG. 1 illustrates a BOM 100-1 for the end product A 105-1. As shown, the BOM 100-1 for product A 105-1 includes identifiers of the components products 105-2 through 105-5, otherwise referred to as product B, product C, product D, and product E. In addition to the identifiers of the component products, the BOM 100-1 also includes a description of the sequential relationship among the component products. For example, BOM 100-1 shows that product A is made from or includes product B and product C. Similarly, the BOM 100-1 shows that product B is made from or includes product D and product E. Accordingly, products D and E need to be received by or produced by the final assembly plant before product B can be produced. Since product A includes product B and product C, both product B and product C must be produced or received before product A can be produced.

The information contained in the BOMs, like BOM 100-1, is useful, however some analysis of the BOM 100-1 can only be performed with information about component products B, C, D, and E that is not necessarily included in BOM 100-1 for product A. To obtain information about the component products B, C, D, and E, a central business system would need to look to information contained in the BOMs 100 for each of the component products. For example, the central business system may need to reference BOMs 100-2 and 100-3 for products C and E, shown in FIGS. 1B and 1C. Since the BOMs 100-2 and 100-3 can originate from different internal manufacturing plants, the information contained in each BOM 100 may not be readily available to a particular assembly plant. Even if the BOMs 100 for the component products in the central business system are available, the information contained in the component product BOMs 100 may not be in a defined format or state relevant to the end product. The central business system would need to translate the information in the BOMs 100 to a locally meaningful format. Thus, obtaining, translating, and analyzing the BOMs 100 of component products for a particular end product adds additional administrative and computational overhead in the various functions of a central business system.

### SUMMARY

Embodiments of the present disclosure include systems and methods for generating cross-plant BOMs for mixed-source products. One embodiment of the present disclosure includes a method for generating a cross-plant BOM using BOMs received from multiple plants for multiple end products used in the production of a final end product. The method includes defining a plant group. The plant group includes a portion of the manufacturing plants associated with various business scenarios for one or more business entities. The method can include receiving multiple BOMs for multiple end products that are used as component products in another end product. Each BOM is associated with a corresponding manufacturing plant and includes multiple component product identifiers. The method further includes determining a portion of the BOMs associated with the portion of the corresponding manufacturing plants within the plant group, generating a cross-plant BOM that includes a first BOM, associated with the plant group, for the first end product, and a second BOM, in the portion BOMs, for a second end product.

In one embodiment, the second end product matches a first component product identifier in the plurality of component product identifiers in the first BOM for the first end product.

In one embodiment, building the cross-plant BOM includes adding the second BOM to the first BOM.

In one embodiment, building the cross-plant BOM includes associating the first component product identifier with the second BOM.

In one embodiment, the cross-plant BOM further includes a third BOM, associated with the plant group, for a third end product in the plurality of end products. The third end product matches the first component product identifier.

In one embodiment, the third end product matches a second component product identifier in the plurality of component product identifiers in the first BOM for the first end product.

In one embodiment, the third end product matches a first component product identifier in the plurality of component product identifiers in the second BOM for the second end product.

Another embodiment of the present disclosure includes a computer readable medium containing instructions, that when executed by a computer processor configure the computer processor for receiving a plurality of BOMs for a plurality of end products, wherein the plurality of BOMs are associated with a plurality of corresponding manufacturing plants and comprise a plurality of component product identifiers. The instructions can cause the computer processor to be configured for determining a plant group, wherein the plant group comprises a portion of the corresponding manufacturing plants determined to be included in a business entity for the plurality of end products. Additionally, the instructions can also cause the computer processor to be configured for determining a portion of the plurality of BOMs associated with the plant group, and generating a cross-plant BOM comprising a first BOM, associated with the plant group, for the first end product, and a second BOM, associated with the plant group, for a second end product in the plurality of end products.

Yet another embodiment includes a system having one or more computer processors, and a computer readable medium containing instructions, that when executed configure the one or more computer processors to: receive a plurality of BOMs for a plurality of end products, wherein the plurality of BOMs are associated with a plurality of corresponding manufacturing plants and comprise a plurality of component product identifiers, determine a plant group, wherein the plant group comprises a portion of the corresponding manufacturing plants determined to be included in a business entity for the plurality of end products, determine a portion of the plurality of BOMs associated with the plant group, and generate a cross-plant BOM comprising a first BOM, associated with the plant group, for the first end product, and a second BOM, associated with the plant group, for a second end product in the plurality of end products.

The following detailed description and accompanying drawings provide a better understanding of the nature and advantages of the present disclosure.

### BRIEF DESCRIPTION OF THE DRAWINGS

FIG. 1A illustrates a conventional bill of materials that includes component products produced internally and component products procured externally.

FIGS. 1B and 1C illustrate conventional bills of materials for end products that are used as component products in the conventional bill of materials illustrated in FIG. 1A.

FIG. 2 illustrates a plant group according to one embodiment of the present disclosure.

FIG. 3 illustrates a cross-plant bill of materials, according to one embodiment of the present disclosure.

FIG. 4 illustrates fixed bills of materials for identical end products produced by different manufacturing plants, according to one embodiment of the present disclosure.

FIG. 5 illustrates configured bills of materials produced by different manufacturing plants, according to one embodiment of the present disclosure.

FIG. 6 illustrates cross-plant bills of materials that include configured BOMs with the same component product, but with different bills of materials, according to one embodiment of the present disclosure.

FIG. 7 illustrates a cross-plant bill of materials that includes alternative positions for the same component product. Each of the alternative positions has a different bill of material, according to one embodiment of the present disclosure.

FIG. 8 is a flowchart of a method for generating a cross-plant bill of materials, according to one embodiment of the present disclosure.

FIG. 9 is a schematic of a computer system and network connections that can be used to implement various embodiments of the present disclosure.

### DETAILED DESCRIPTION

Described herein are techniques for systems and methods for cross-plant BOMs for mixed-source end products. In the following description, for purposes of explanation, numerous examples and specific details are set forth in order to provide a thorough understanding of the present invention. It will be evident, however, to one skilled in the art that the present invention as defined by the claims may include some or all of the features in these examples alone or in combination with other features described below, and may further include modifications and equivalents of the features and concepts described herein.

Embodiments of the present disclosure include systems and methods for generating cross-plant BOMs that can be used in business systems and processes. Use of the cross-plant BOMs can provide for improved efficiency and reduced costs in the performance of various business analysis and processes in compliance with legal regulations, tax, and other governmental and commercial regulatory or trade association requirements. In one example embodiment, a cross-plant BOM provides a complete view of a particular end product that is produced from and/or includes various component products from multiple plants. Accordingly, central business systems, such as enterprise resource planning (ERP) systems or global trade services (GTS) systems, can get an overview of a particular mixed-source product based on the BOMs provided by the source plant of each component product in each step the analysis. The cross-plant BOM can be generated by analyzing the BOMs for each of the component products of a particular end product. Analysis of the BOMs for the component products can include matching the description or identifier of the component products with the description or identifier of a final product in another BOM. As used herein, the terms end product and component product can refer to any final or intermediate material, component, assembly, or sub assembly in a particular BOM produced by one or more manufacturing plants. While the end product of a particular BOM may be the end product for a particular manufacturing plant, it may also be a component product in another BOM for another end product produced by another manufacturing plant. Also, as used herein the terms manufacturing plant and plant can be used interchangeably to refer to a factory, assembler, or processor that fabricates, assembles, or manufactures various end and component products.

In some embodiments, the source plants that produce the component and end products of a mixed-source product can be part of a plant group. The plant group can include internal manufacturing plants, i.e., plants that are operated by a single business entity and plants that are operated by different business entities. As illustrated in FIGS. 1A-1C, products 105 that are produced internally are indicated with solid outlines and products 105 that are procured or produced externally are indicated with dashed outlines. The information and/or the level of detail in BOMs 100 of internally and externally produced products can vary, e.g., BOMs 100 from external plants may not have as much detail or may not include the information in the preferred format of the receiving central system.

When plants in a particular plant group produce one or more end products for use in another end product, the BOMs 100 associated with the end products can include information that indicates which plant produced the corresponding end product 105. For example, the BOM 100-1 for product A 105-1 shown in FIG. 1, which includes component products C 105-3 and E 105-5, can be produced according to the manufacturing scheme 200 illustrated in FIG. 2. As shown, final product A 105-1 can be produced by manufacturing plant 110-1 from the products C 105-3 and E 105-5 it receives from plants 110-2 and 110-3, respectively. Each one of the plants 110 can provide a corresponding BOM 100 for the end product 105 it produces. In the specific example shown, plant 110-1 provides BOM 100-1 for product A 105-1. Plant 110-2 provides BOM 100-2 for product C 105-3. Plant 110-3 provides BOM 100-3 for product E 105-5. In one embodiment, in which all of the plants 110 are associated with plant group 115, BOMs 100 for each product 105 produced by each of the corresponding plants 110 may include information identifying the plant 110 produced the corresponding product 105 and/or the BOM 100, as well as information identifying the plant group to which the products 105 may be associated. Accordingly, each particular BOM 100 for a particular product 105 can be associated with and be unique to a particular plant 110 of the plant group.

To generate a cross-plant BOM 300 illustrated in FIG. 3, the BOMs 100 for each product 105 associated with plants 110 included in a particular plant group 115 can be analyzed by the receiving central system. In the example shown, the BOMs 100-1, 100-2, and 100-3 can be received by a central system from plants 110-1, 110-2, and 110-3 associated with a particular plant group 115. Accordingly, each of the received BOMs 100 can indicate that the respective end products 105 are associated with an internal plant 110. Based on the information in each one of the BOMs, the central system can determine that the BOM 100-1 from plant 110-1 for end product A 105-1 includes component product identifiers for component products C 105-3 and E 105-5, that match end products of BOM 100-2 and BOM 100-3 received from plants 110-2 and plant 110-3. For example, the central system can check each of the identifiers of the component products 105 of each BOM 100 to determine if any of the other received BOMs 100 indicates an end product 105 that matches one of the component products 105. If a match is determined, then the BOM 100 for the end product that matches the component product can be inserted into or linked to the BOM 100 of the end product in which it is listed as a component product.

As illustrated by the specific example shown in FIG. 3, end product C 105-3 in the BOM 100-2 matches a component product of product A 105-1 in BOM 100-1. Product E 105-5 of BOM 100-3 matches another component product of product A 105-1 in BOM 100-1. Accordingly, BOM 100-2 for product C 105-3 received from plant 110-2 may be inserted into or linked to the BOM 100-1 for product A 105-1 produced by plant 110-1. Similarly, the BOM 100-3 for product E 105-5 received from plant 110-3 may be inserted into or linked to the BOM 100-1 for product A 105-1 produced by plant 110-1. The resulting data structure is a cross-plant BOM 300 for plants 110-1 through 110-3 for product A 105-1. The resulting cross-plant BOM 300 can then be used by various other functions of the central system to reduce computational and administrative overhead. Instead of determining various attributes for each constituent BOM 100 of each component product for a particular end product, such as product A 105-1, each time the information is needed, the central system reuse the cross-plant BOM 300 as a single source of information for analysis of legal, quality, cost, regulatory, compliance and other attributes for the end product 105. For some analysis, the central system can determine that only the lowest level products 105, e.g., products D, H, I, and J, are the determinative products in any particular piece of analysis, thus avoiding the need to perform the analysis for the intermediate component products, such as product E 105-5 and product C 105-3.

In various embodiments, both fixed BOMs and configurable BOMs can be used to generate a cross-plant BOM. As used herein, a fixed BOM, which can also be referred to as a static BOM, defines a particular product from one or more plants. A configurable BOM can be based on a fixed BOM and configured by the final assembler or the end consumer by choosing or excluding some of the component products in the fixed BOM. Normally a configured BOM is defined for a particular product from one plant. While some end products represented by a fixed BOM can be unique to a particular plant, other end products represented by fixed BOMs from multiple plants can be non-unique. Such BOMs can vary in component products used and by alterations to standardized specifications. Because end products can be produced by multiple plants, the BOMs to the plants producing the particular end product can include a unique plant identifier, e.g. through specifying criteria or configuration, to differentiate the end product by the corresponding source plant. Thus, the BOMs for common product from two separate plants can be distinguished from one another. In some embodiments, the distinguishing element between two BOMs 100 for identical products 105 can be a unique identifier included in each of the BOMs 100. For example, as depicted in FIG. 4, product C 105-3 can be produced with BOMs 100-X and 100-Y by plants 110-X and 110-Y. To distinguish between the BOM 100 for the two identical products C 105-3, each of the respective BOMs 100-X and 100-Y can include unique identifier that is associated with a particular plant.

When two BOMs 100 for a particular product 105 exist with unique plant identifier, various embodiments of the present disclosure may include both of the BOMs 100 in the resulting cross-plant BOM. Thus, if product C 105-3 is included as a component product in another BOM 100 of another end product 105, then the corresponding BOM could be inserted into or linked to that particular BOM 100 as part of the cross-plant BOM.

FIG. 5 illustrates two possible configured BOMs 100-C1 and BOM 100-C2 for product C 105-3. As shown, BOM 100-C1 and BOM 100-C2 indicate product C 105-3 as the end product. However, BOM 100-C1 lists product D 105-4, product m 105-m, product D 105-5 as the component products. In contrast, BOM 100-C2 lists product D 105-4, product n 105-n, product D 105-5 as the component products. Accordingly, BOM 100-C1 and BOM 100-C2 differ by the products m and n. The choice between products m and n can be left up to the final assembler or the end consumer. For example, products C 105-3 can be a car seat in an end product A 105-1 that includes a car. Product m 105-m can represent a beige color leather, while product n 105-n can represent a black color leather. Each of the configured BOMs 100-C1 and 100-C2 can include a unique identifier to identify the particular configuration of end product C 105-3. The unique identifiers for the configured BOMs can be associated with the particular BOM, the end product, the particular configuration of the end product, and/or the particular plant that produces the particular configuration of end product. For example, identifier C1 can be associated with product C 105-3, configuration 1, and plant 110-V. Similarly, identifier C2 can be associated with product C 105-3, configuration 2, and plant 110-W.

When a configured end product of a configurable BOM 100 matches a component product of another end product of another BOM 100, then the configured BOM 100 can be inserted into or linked to the BOM 100 of the other end product. Any and all configurable BOMs for each configuration of a particular configured end product can be inserted into or linked to the BOM of the other end product. In some embodiments, as is illustrated in FIG. 6, cross-plant BOMs 300-1 or 300-2 can be generated depending on the configuration; BOM 100-C1 or BOM 100-C2 can be inserted into or links to BOM 105-1.

When two BOMs 100 for a particular product 105 exist without the unique plant identifier, embodiments of the present disclosure may include both of the BOMs 100 in the resulting cross-plant BOM. Thus, if product C 105-3 is included as a component product in another BOM 100 of another end product 105, then both BOM 100-X and BOM 100-Y could be inserted into or linked to that particular BOM 100 as part of the cross-plant BOM. FIG. 7 illustrates possible resulting cross-plant BOM 100-3. In such embodiments, BOMs 100-X and 100-Y can be dealt with as alternative positions for the cross-plant BOM 100-3 in which two BOMs 100-X and 100-Y are both inserted into or linked to the BOM 105-1 in which product C 105-3 is listed as a component product. Thus, a single alternative position cross-plant BOM 100-3 can be generated, as illustrated in FIG. 7.

In one embodiment, a central system can also determine that some of the component products 105, such as component products D, H, I, and J, are associated with an external plant, e.g., a plant not owned, operated, managed, or otherwise controlled by the central system. For such products that are not produced by an internal plant, the central system may have limited information. Accordingly, for those products 105 that are determined to be produced by an external plant, the central system may determine not to attempt matching the externally produce product 105 with a received BOM to avoid running superfluous checks.

FIG. 8 illustrates a method 800 for generating cross-plant BOMs according to various embodiments of the present disclosure. Method 800 begins at 810, in which a central system receives multiple BOMs for multiple products from multiple plants. Receiving the BOMs can occur when the associated end products are sent or received by the originating and receiving plants, respectively. The BOMs can be received in real time or in batches according to the data acquisition schedule of the central system. Once the BOMs are received, the central system can begin to analyze the individual BOMs. In anticipation of analyzing individual BOMs, the central system can determine if the plant groups have been previously defined, at determination 820. As mentioned above, the plant groups can be defined by a listing of the plants used in the production of various component products and particular final end products. Accordingly, plants that produce component products used in the production of another component or end product can be grouped together in a particular plant group. Also the plant that performs the final assembly or production of the final end product that uses each of the intermediate component and end products can be included in the particular plant group. In the event that the plant group was not previously defined, the central system can determine the plant groups in 825. In such embodiments, the plant groups can be determined by prompting a user to define the plant groups manually based on knowledge of logistical processes in the supply chain and lines of production. Alternatively, the plant groups can be determined by analyzing productions plans and/or schedules associated with a particular end product or BOM for that end product. In various embodiments, the central system can also confirm that the previously defined plant groups are still valid by prompting a user or analyzing corresponding data in one or more sub systems, e.g., a logistics application.

If the plant groups have been previously defined, or if the central system can determine one or more plant groups for the received BOMs, then the central system can reference the plant group definitions, and move on to determine if the low-level-codes, or other classifications, assigned to each end product and component product in the BOMs have been harmonized, in determination 830.

The low-level-codes of a particular BOM correspond to the lowest level process, or the earliest step, in the production process of the producing plant in which each component product in the BOM is produced. Even in commonly owned or operated plants, the BOMs for each component product can be different according to a different set of production steps or processes specific to each individual plant. Thus, two identical end products that include identical component products can have different low-level-codes due to the difference in the manufacturing steps performed by the plants that produced the component products and end products. As such, in some embodiments, to generate cross-plant BOMs, the low-level-codes included in the constituent BOMs can be harmonized with one another. Accordingly, if the low-level-codes for the BOM are determined not to be harmonized with one another in determination 830, then the central system can harmonize the low-level-codes at 835. In one embodiment, the low-level-code for each component product in each corresponding BOM is set to the lowest low-level-code associated with that particular component product in all of the BOMs.

Once the low-level-codes are harmonized, the central system can determine subsets of BOMs based on the defined plant groups at 840. By referencing the plant group definitions, the central system can filter the received BOMs to determine which BOMs are associated with one another and/or include end products and component products that match one another. Each set of BOMs determined to be associated with each of the defined plant groups can be analyzed in actions 850 through 895. At 850, each end product of each BOM in a particular plant group is compared with the component products in each of the other BOMs in the particular plant group. If there is no match, the central system can go to the next BOM in the N^{th} plant group at 855, where N is natural number. If there is a match, then the BOM of the end product determined to match the component product in the other BOM can be associated with the component product in the other BOM at 860. In one embodiment, associating the BOM of the end product with the component product in the other BOM can include inserting the BOM of the end product into the other BOM in which the end product is listed as a component product.

Once the match between one or more BOMs in the plant group has been made and the corresponding association is determined, then the central system can check if there are more BOMs in the N^{th} plant group to analyze. If there are, then the central system can move to the next BOM at 855. Actions 850 to 870 can be repeated until all end products of the BOMs in the N^{th} plant group have been compared with component products of the other BOMs in the N^{th} plant group. When the central system determines that there are no more BOMs in the N^{th} plant group at determination 870, then the central system can output the resulting cross-plant BOM for the final end product of the N^{th} plant group at 880.

When the central system is done with the N^{th} plant group, and it determines there are more plant groups to process at 890, it can move onto the next plant group and repeat actions 840 through 890, for all or some of the remaining plant groups. When all the plant groups are processed, the central system can end method 800.

FIG. 9 illustrates an example computer system and networks that may be used to implement one embodiment of the present disclosure. Computer system 910 includes a bus 905 or other communication mechanism for communicating information, and a processor 901 coupled with bus 905 for processing information. Computer system 910 also includes a memory 902 coupled to bus 905 for storing information and instructions to be executed by processor 901, including instructions for performing the techniques described above. This memory may also be used for storing temporary variables or other intermediate information during execution of instructions to be executed by processor 901. Possible implementations of this memory may be, but are not limited to, random access memory (RAM), read only memory (ROM), or both. A storage device 903 is also provided for storing information and instructions. The information instructions can be in the form of computer readable code stored on the storage device, accessible and executable by processor to implement various techniques and methods of the present disclosure. Common forms of storage devices include non-transient, non-volatile computer readable media, for example, a hard drive, a magnetic disk, an optical disk, a CD, a DVD, a flash memory, a USB memory card, or any other medium from which a computer can read.

Computer system 910 may be coupled via the same or different information bus, such as bus 905, to a display 912, such as a cathode ray tube (CRT) or liquid crystal display (LCD), for displaying information. An input device 911 such as a keyboard and/or mouse is coupled to a bus for communicating information and command selections from the user to processor 901. The combination of these components allows the user to communicate with the system.

Computer system 910 also includes a network interface 904 coupled with bus 905. Network interface 904 may provide two-way data communication between computer system 910 and the local network 920. The network interface 904 may be a digital subscriber line (DSL) or a modem to provide data communication connection over a telephone line, for example. Another example of the network interface is a local area network (LAN) card to provide a data communication connection to a compatible LAN. Wireless links is also another example. In any such implementation, network interface 904 sends and receives electrical, electromagnetic, or optical signals that carry digital data streams representing various types of information.

Computer system 910 can send and receive information, including messages or other interface actions, through the network interface 904 to an Intranet or the Internet 930. In the Internet example, software components or services may reside on multiple different computer systems 910 or servers 931 across the network. Software components described above may be implemented on one or more servers. A server 931 may transmit messages from one component, through Internet 930, local network 920, and network interface 904 to a component or container on computer system 910, for example. Software components of a composite application may be implemented on the same system as other components, or on a different machine than other software components. This process of sending and receiving information between software components or one or more containers may be applied to communication between computer system 910 and any of the servers 931 to 935 in either direction. It may also be applied to communication between any two servers 931 to 935.

The above description illustrates various embodiments of the present invention along with examples of how aspects of the present invention may be implemented. The above examples and embodiments should not be deemed to be the only embodiments, and are presented to illustrate the flexibility and advantages of the present invention as defined by the following claims. Based on the above disclosure and the following claims, other arrangements, embodiments, implementations and equivalents will be evident to those skilled in the art and may be employed without departing from the spirit and scope of the invention as defined by the claims.

What is claimed is:

1. A method comprising:
receiving, in a computer system, a plurality of bills of materials (BOMs) for a plurality of end products, wherein the plurality of BOMs are associated with a plurality of corresponding manufacturing plants;
determining, in the computer system, a plant group, wherein the plant group comprises a portion of the corresponding manufacturing plants determined to be included in logistical processes for a first end product in the plurality of end products;
determining, in the computer system, a portion of the plurality of BOMs associated with the plant group; and
generating, in the computer system, a cross-plant BOM comprising a first BOM, associated with the plant group, for the first end product, and a second BOM associated with the plant group for a second end product in the plurality of end products.

2. The method of claim 1 wherein the plurality of BOMs comprise a plurality of component product identifiers, and wherein the second end product matches a first component product identifier in the plurality of component product identifiers in the first BOM for the first end product.

3. The method of claim 2 wherein the cross-plant BOM further comprises a third BOM, associated with the plant group, for a third end product in the plurality of end products, wherein the third end product matches the first component product identifier.

4. The method of claim 2 wherein the cross-plant BOM further comprises a third BOM associated with the plant group for a third end product in the plurality of end products, wherein the third end product matches a second component product identifier in the plurality of component product identifiers in the first BOM for the first end product.

5. The method of claim 2 wherein the cross-plant BOM further comprises a third BOM associated with the plant group, for a third end product in the plurality of end products, wherein the third end product matches a first component product identifier in the plurality of component product identifiers in the second BOM for the second end product.

6. The method of claim 1 wherein generating the cross-plant BOM further comprises adding the second BOM to the first BOM.

7. The method of claim 1 wherein generating the cross-plant BOM further comprises associating the first component product identifier with the second BOM.

8. A non-transitory computer readable medium comprising instructions, that when executed by a computer processor configures the computer processor for:
receiving a plurality of bills of materials (BOMs) for a plurality of end products, wherein the plurality of BOMs are associated with a plurality of corresponding manufacturing plants and comprise a plurality of component product identifiers;
determining a plant group, wherein the plant group comprises a portion of the corresponding manufacturing plants determined to be included in logistical processes for a first end product in the plurality of end products;
determining a portion of the plurality of BOMs associated with the portion of the corresponding manufacturing plants; and
generating a cross-plant BOM comprising a first BOM, associated with the plant group, for the first end product, and a second BOM, associated with the plant group, for a second end product in the plurality of end products.

9. The non-transitory computer readable medium of claim 8 wherein the second end product matches a first component product identifier in the plurality of component product identifiers in the first BOM for the first end product.

10. The non-transitory computer readable medium of claim 9 wherein the cross-plant BOM further comprises a third BOM, associated with the plant group, for a third end product in the plurality of end products, wherein the third end product matches the first component product identifier.

11. The non-transitory computer readable medium of claim 9 wherein the cross-plant BOM further comprises a third BOM, associated with the plant group, for a third end product in the plurality of end products, wherein the third end product matches a second component product identifier in the plurality of component product identifiers in the first BOM for the first end product.

12. The non-transitory computer readable medium of 9 wherein the cross-plant BOM further comprises a third BOM, associated with the plant group, for a third end product in the plurality of end products, wherein the third end product matches a first component product identifier in the plurality of component product identifiers in the second BOM for the second end product.

13. The non-transitory computer readable medium of claim 8 wherein generating the cross-plant BOM further comprises adding the second BOM to the first BOM.

14. The non-transitory computer readable medium of claim 8 wherein generating the cross-plant BOM further comprises associating the first component product identifier with the second BOM.

15. A system comprising:
one or more computer processors; and
a computer readable medium comprising instructions that when executed configure the one or more computer processors to:
receive a plurality of bills of materials (BOMs) for a plurality of end products, wherein the plurality of BOMs are associated with a plurality of corresponding manufacturing plants and comprise a plurality of component product identifiers;
determine a plant group, wherein the plant group comprises a portion of the corresponding manufacturing plants determined to be included in logistical processes for a first end product in the plurality of end products;
determine a portion of the plurality of BOMs associated with the portion of the corresponding manufacturing plants; and
generate a cross-plant BOM comprising a first BOM, associated with the plant group, for the first end product, and a second BOM, associated with the plant group, for a second end product in the plurality of end products.

16. The system of claim 15 wherein the second end product matches a first component product identifier in the plurality of component product identifiers in the first BOM for the first end product.

17. The system of claim 16 wherein the cross-plant BOM further comprises a third BOM, associated with the plant group, for a third end product in the plurality of end products, wherein the third end product matches the first component product identifier.

18. The system of claim 16 wherein the cross-plant BOM further comprises a third BOM, associated with the plant group, for a third end product in the plurality of end products, wherein the third end product matches a second component product identifier in the plurality of component product identifiers in the first BOM for the first end product.

19. The system of claim 16 wherein the cross-plant BOM further comprises a third BOM, associated with the plant group, for a third end product in the plurality of end products, wherein the third end product matches a first component product identifier in the plurality of component product identifiers in the second BOM for the second end product.

20. The system of claim 15 wherein generating the cross-plant BOM further comprises associating the first component product identifier with the second BOM.
